(19) United States
(12) Patent Application Publication
(10) Pub. No.: US 2018/0298953 A1
(43) Pub. Date: Oct. 18, 2018

(54) DISENGAGING MEMBER FOR RETRACTABLE AERODYNAMIC FLAP OF A MOTOR VEHICLE

(71) Applicant: Compagnie Plastic Omnium, Lyon (FR)

(72) Inventors: Gerald ANDRE, Saint Denis en Bugey (FR); Bertrand MAZUE, Lyon (FR); Francis HOLLEVILLE, Saint Remy les Chevreuse (FR)

(73) Assignee: Compagnie Plastic Omnium, Lyon (FR)

(21) Appl. No.: 15/539,326

(22) PCT Filed: Dec. 22, 2015
(86) PCT No.: PCT/FR2015/053708

§ 371 Date: Jun. 23, 2017

(30) Foreign Application Priority Data
Dec. 26, 2014 (FR) 1463348

(51) Int. Cl. F16D 7/10; B62D 35/00; F16D 7/04; F16D 43/202; F16D 43/208

(52) U.S. Cl. CPC F16D 7/10; B62D 35/005; F16D 43/208; F16D 43/2028; F16D 7/048

(57) ABSTRACT

A disengaging member for releasing a link between a motor and a shaft rotated by the motor, the disengaging member including first and second elements capable of fitting together in a direction substantially parallel to the shaft, one element being capable of being connected to the motor by a link that enables the element to be rotated by the motor, and the other element being capable of being attached to the shaft. The first element includes at least one recess at the fitting interface between the two elements, the second element includes at least one resilient member exerting a radial force on the fitting interface via an insertion member capable of being inserted into the recess, keeping the two elements secured to one another for rotation therewith up until a predefined transmission torque between the insertion member and the first element.

### FIELD OF THE INVENTION

This invention relates to the field of motor vehicles. In particular, the invention relates to a disengaging member for releasing a link between a motor means and a shaft, in particular for a vehicle comprising at least one retractable aerodynamic flap.

### BACKGROUND OF THE INVENTION

Vehicles comprising mobile elements integrated under the front bumper of the vehicle are described for example in French Patent FR2821593, FR2927303 and FR2864811.

Such retractable flaps are designed to improve the vehicle aerodynamics, for example by reducing the vehicle drag and consumption, especially at speeds greater than 70 km/h. These flaps can be placed at various positions on the bodywork: front, sides and/or rear.

When the flaps are in the folded (retracted) position under the front bumper, they are protected from impacts against obstacles such as curbs. This position folded under the bumper is therefore suitable for driving at low speed in towns or on roads with surface defects or a stone pavement for example.

Such flaps are especially useful on vehicles with high ground clearance such as 4-wheel drive vehicles, SUVs and MPVs. These vehicles, in fact, consume more fuel, especially due to a ground clearance involving high aerodynamic losses.

These retractable aerodynamic flaps can simply be mounted on a shaft and rotated on this shaft by a motor.

When driving, in other words when the vehicle is running, the rotation mechanism of such flaps is sometimes blocked, due to the presence of mud, snow, ice or foreign bodies for example, or if the aerodynamic load is too high. This could damage the motor. The motor must not force to move the flap into the folded position, when the vehicle slows down or stops, while it is blocked. Similarly, if the mechanism becomes clogged when stopped, the motor must not force to move the flap into the extended position, when the vehicle is moving at high speed.

Moreover, it is sometimes necessary to perform maintenance operations on the flap when the vehicle is stationary, therefore without electrical control. Users may need to open or close the flap after it has been blocked in order to clean it, or remove elements trapped by the flap (branch, leaves, etc.). Users must therefore be able to actuate rotation of the flap to an open position or to a retracted position, independently of the electrical or electronic control controlling the motor.

Solutions are known to avoid damaging the actuation mechanism, under the excessive force applied to the flap or to be applied to the flap by the motor, such as unclipping the retractable part, or a deformation using the flexibility of the part.

However, no solution is really adapted to protect a large retractable and rigid system, or meet the need to perform maintenance on the flap in the closed position.

### OBJECT AND SUMMARY OF THE INVENTION

The purpose of this invention is to provide improvements to the retractable flaps to avoid damaging the flap actuation mechanism and to allow maintenance on the flap when the vehicle is stationary.

This purpose is achieved by a radial disengaging member on the motor coupling.

Thus, an object of the invention is a disengaging member for releasing a link between a motor means and a shaft rotated about itself by said motor means, comprising first and second elements capable of fitting together in a direction substantially parallel to the shaft, one being capable of being connected to the motor means by a link that enables it to be rotated by the motor means, and the other element being capable of being attached to the shaft. The first element comprises at least one recess at the fitting interface between the two elements. The second element comprises at least one resilient means exerting a radial force on the fitting interface via an insertion member capable of being inserted into the recess, keeping the two elements secured to one another for rotation therewith up until a predefined transmission torque between the insertion member and the first element. The resilient means, the recess and the insertion member being configured so that, beyond this predefined torque, the insertion member compresses the resilient means and exits the recess, thereby releasing the rotation between the two elements.

Such disengaging member therefore disengages the motor shaft from the shaft carrying the flap. It can be placed directly on the shaft carrying the flap, and act at various levels, for example in a gearbox positioned between the motor shaft and the shaft carrying the flap.

Moreover, such a disengaging member can be installed on any type of system, any type of vehicle.

Such a disengaging member protects the motor under all circumstances, even when powered down, which is not the case with over-torque detection electronics, and thus also allows maintenance.

According to one example, the predefined torque may be between 5 Nm and 20 Nm.

Advantageously, the resilient means is a spring.

According to the invention, the disengaging member may comprise an axis provided with an insertion member at each of its ends.

According to one embodiment, the first element comprises several recesses on the fitting interface. The insertion member is thus preferably capable of being inserted in an adjacent recess on the periphery of the first element after a predefined angle of rotation. This predefined angle of rotation is preferably substantially between 10° and 30°.

According to one embodiment, the insertion member may be cylindrical or spherical, and the recess may have a complementary shape such as a half-cylinder. For example, the insertion member may be a ball or have a V shape.

According to a particular embodiment, the recess comprises a slope or radius of curvature for disengaging the member, different from the slope or radius of curvature for inserting the member.

According to another embodiment, the disengaging member comprises a handle capable of compressing the resilient means, so as to reduce the forces required to disengage the insertion member.

Advantageously, the two elements are made of thermoplastic material.

According to an advantageous embodiment, one end of the resilient means forms the insertion member, or the insertion member is added to the resilient means by thermoplastic overmolding.

Lastly, the insertion member may be a molded section of the second element, located on the fitting interface of the second element, and the resilient means may be an area on the periphery of the insertion member having flexibility in compression such that the insertion member is capable of moving radially.

The invention also relates to an assembly of a motor means, a shaft rotated by said motor means, and a disengaging member according to the invention.

The first element is preferably connected to the motor means by a link that enables it to be rotated by the motor means, and the second element is attached to the shaft.

The disengaging member may comprise an axis provided with an insertion member at each of its ends, the axis being substantially perpendicular to the shaft.

According to one embodiment, the assembly comprises a gearbox.

The invention also relates to a retractable aerodynamic system for a motor vehicle, comprising an assembly according to the invention, and an aerodynamic flap attached to the shaft.

According to one embodiment, the aerodynamic flap is capable of pivoting by an angle close to 90°, and in which the insertion member is capable of being inserted in an adjacent recess on the periphery of the first element after a predefined angle of rotation substantially between 10° and 30°.

The predefined torque may be between 5 Nm and 10 Nm.

Lastly, for the direction of rotation of the aerodynamic flap corresponding to its opening, the recess may comprise a slope for disengaging the insertion member that is less than the insertion slope.

### BRIEF DESCRIPTION OF THE DRAWINGS

The invention will be better understood on reading the accompanying figures, which are given solely by way of example and not limiting in any way, in which:

FIG. 1 illustrates one half and the axis of symmetry of a retractable aerodynamic system for a motor vehicle, comprising a motor means, a shaft rotated by the motor means and carrying the retractable flap, and a disengaging member according to the invention.

FIG. 2 illustrates an example of a disengaging member according to the invention.

FIG. 3 illustrates in detail a first element of the disengaging member.

FIG. 4 illustrates in detail a second element of the disengaging member.

FIG. 5 illustrates an embodiment wherein the resilient means includes at its end a shape enabling it to act as insertion member.

FIG. 6 illustrates an embodiment wherein the insertion member and the resilient means is a molded section, made in one piece with the second element.

FIG. 7 illustrates a particular embodiment where the resilient means is a wire spring.

### MORE DETAILED DESCRIPTION

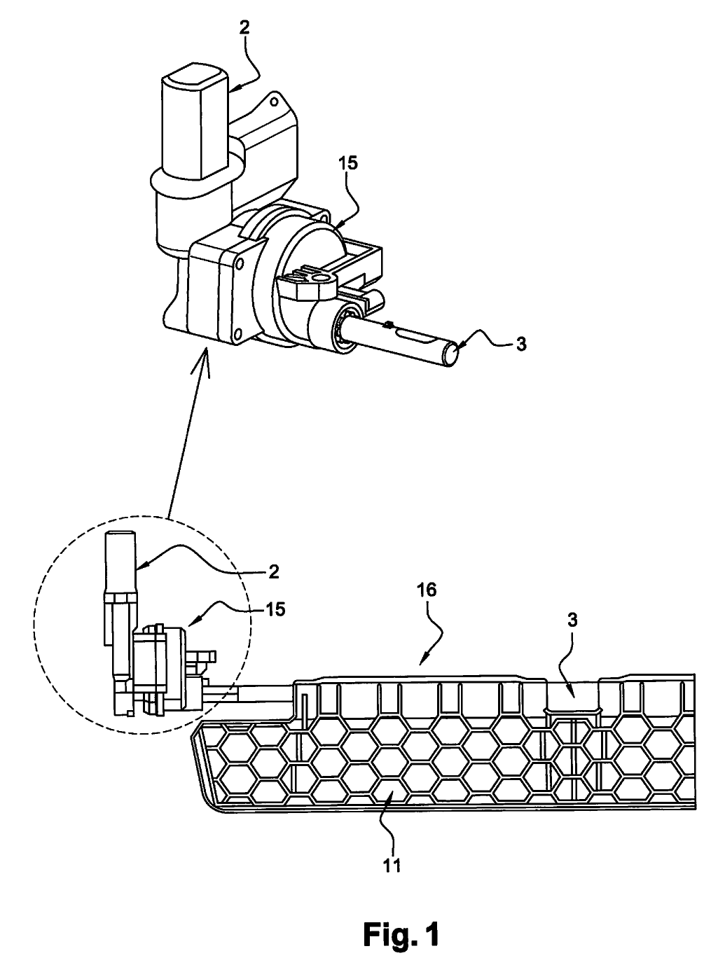

FIG. 1 illustrates a retractable aerodynamic system for a motor vehicle, comprising a disengaging member (1) according to the invention (in element 15 on FIG. 1), a motor means (2), and a shaft (3) rotated by the motor means (2) and carrying the retractable flap (11).

As illustrated on FIG. 1, the disengaging member (1) according to the invention is particularly adapted to be mounted on a motor vehicle whose front bumper comprises at least one retractable aerodynamic flap pivotally mounted between a folded position under the front bumper and an extended position in which the deflector projects downwards.

Thus, the invention will be described according to this particular embodiment, wherein the movable flap is retractable and pivoting and mounted on a front bumper of a motor vehicle.

The disengaging member (1) according to the invention allows disengagement of a link between a motor means (2) and a shaft (3) rotated about itself by the motor means (2).

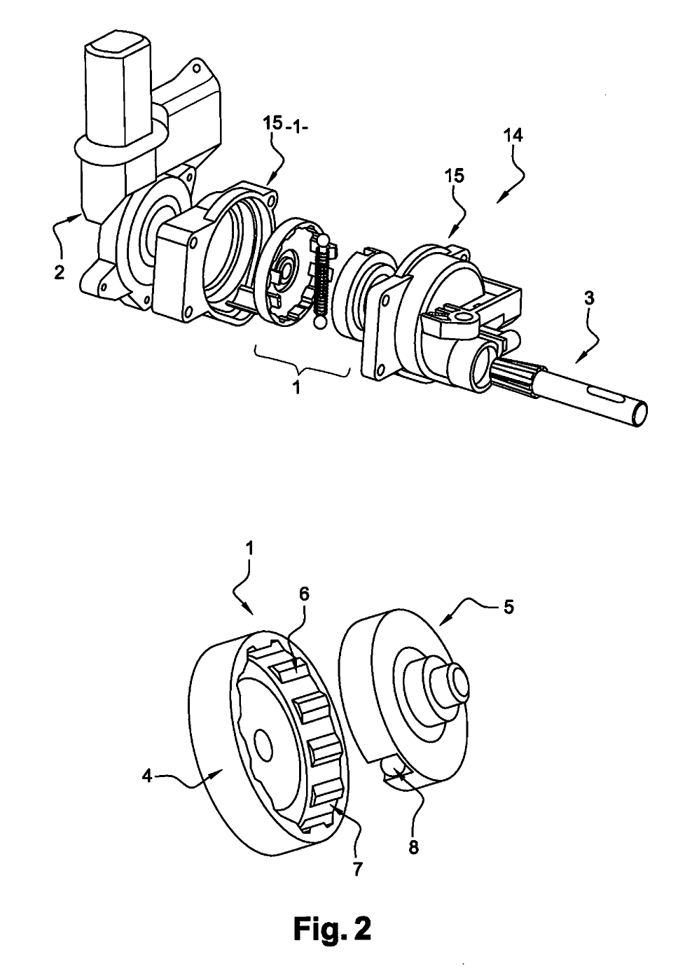

We now refer to FIG. 2 which illustrates a particular embodiment of the disengaging member (1) according to the invention.

The disengaging member (1) comprises first (4) and second (5) elements, one being capable of being connected to the motor means (2) by a link that enables it to be rotated by the motor means (2), and the other element being capable of being attached to the shaft (3). The element (4) may be bell-shaped, as illustrated on FIG. 2.

The first and second elements (4 and 5) are capable of fitting together in a direction substantially parallel to the shaft (3). According to the particular embodiment illustrated, it is the second element (5) which is capable of fitting into the first element (4) as illustrated on FIG. 2, and it is the first element (4) which is connected to the motor.

The two elements (4, 5) are secured to one another for rotation therewith up until a certain torque value by a radial disengageable link, described below.

FIG. 3 represents a view of the first element (4). This first element (4) comprises at least one recess (6) at the fitting interface (7) between the two elements (4, 5). The fitting interface represents the cylindrical surfaces facing each other between the two elements (4, 5) once fitted together: the outer flank of the second element (5) (for example a cylindrical surface) and the inner flank of the first element (4).

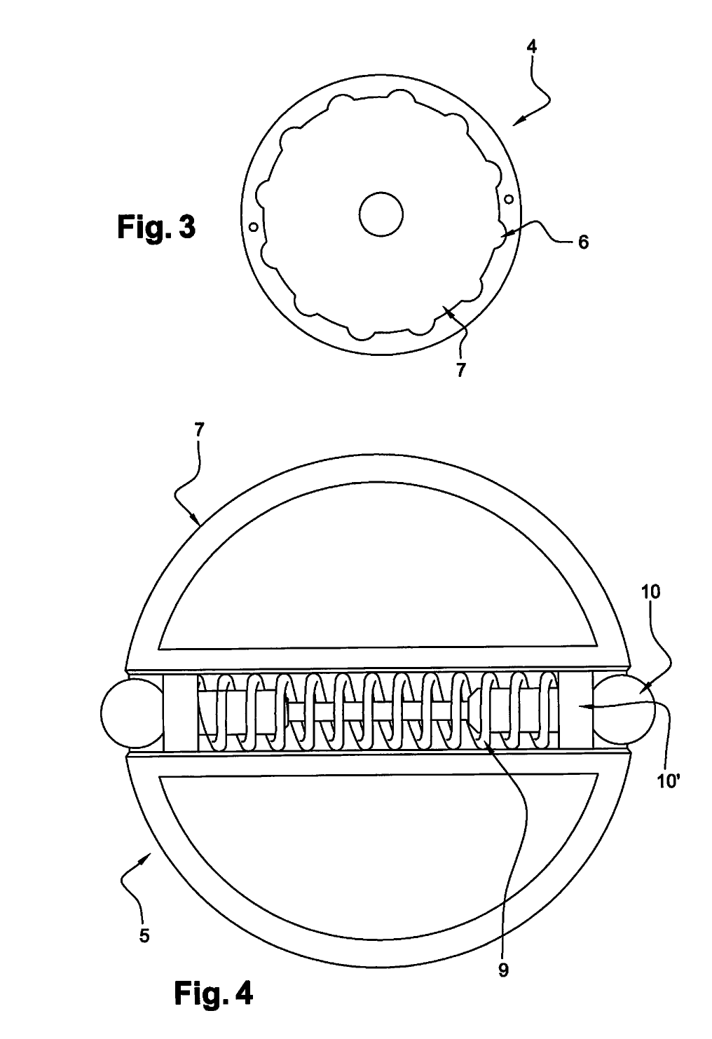

FIG. 4 represents a view of the second element (5). This second element (5) comprises at least one axis (8) provided with at least one resilient means (9). This resilient means (9) exerts a radial force on the fitting interface (7) via an insertion member (10). Thus, axis (8) refers either to the resilient means (9) alone, or to the resilient means (9) and to the insertion member (10).

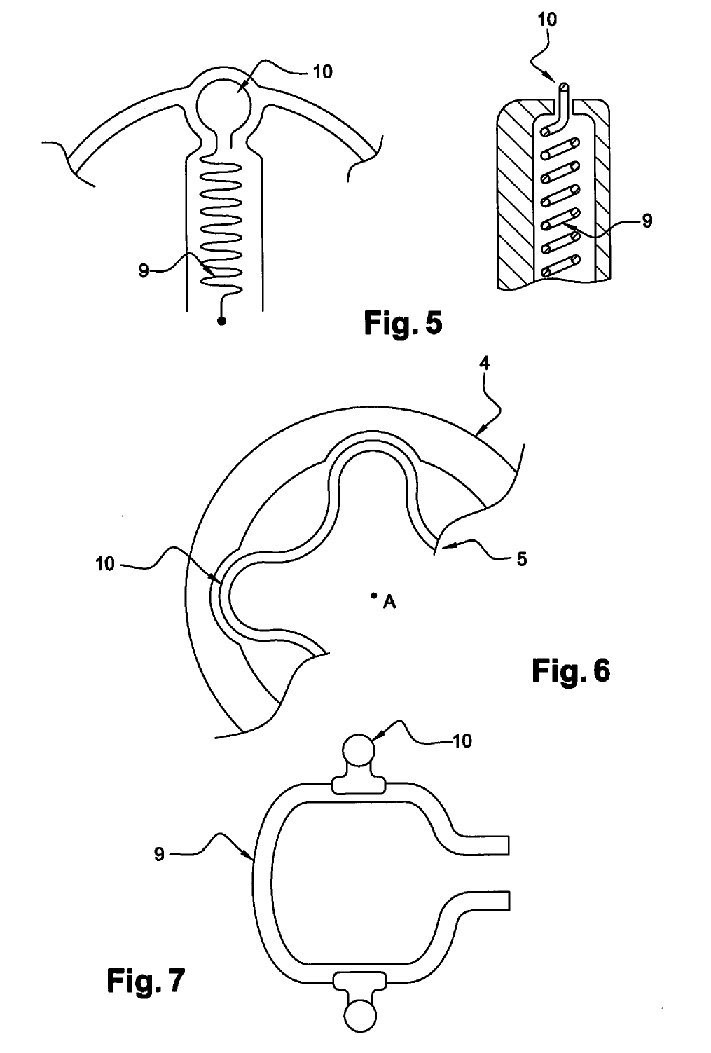

The insertion member (10) may be an element added to the resilient means (9) or be a section of the resilient means (9), such as the end of a spring, for example. For example, according to one embodiment illustrated on FIG. 5, the resilient means (9) includes at its end a shape enabling it to act as insertion member. On the example illustrated on FIG. 5, the resilient means (9) is a wire forming a compression spring and forming at one of its ends a loop whose upper arc acts as insertion member. In an alternative embodiment, in particular to improve the radial guiding in the insertion shape, the insertion member (10) can be integrated by thermoplastic overmolding of the resilient means (9).

According to one embodiment (FIG. 6), the insertion member (10) is a molded section, made in one piece with the second element (5). This insertion member (10) is then a cylindrical or spherical insertion surface, located on the fitting interface of the second element (5). The resilient means (9) is, according to this embodiment, an area on the periphery of each insertion surface, having flexibility in compression such that the insertion surface is capable of moving radially towards its center A under the effect of a predefined torque, and this movement occurs under elastic conditions, in other words without plastic deformation of the element (5). Thus, according to this embodiment, the resilient element (9) is made of plastic and is integrated by molding to the second element (5), and the elastic force is exerted by deformation of this second element (5).

The insertion member (10) may be composed of an element capable of being housed in the recess (6) and a pusher (10′) as illustrated on FIG. 4.

On the example of FIG. 4, the surface of the second element (5) forming the fitting interface (7) may thus comprise openings capable of allowing the insertion member (10) to pass through, so that it comes into contact with the surface of the first element (4) forming the fitting interface (7). In this example again, the axis (8) is housed in a radial channel of the second element (5). In this example again, the axis (8) is positioned diametrically in the element (5).

This insertion member (10) is capable of being inserted in the recess (6), keeping the two elements (4, 5) secured to one another for rotation therewith up until a predefined transmission torque between the axis (8) via the insertion member (10) and the first element (4).

The resilient means (9) is configured so that beyond this predefined transmission torque between the insertion member (10) and the first element (4), the insertion member (10) compresses the resilient means (9) sufficiently to exit the recess (6). After exiting the recess (6), the second element (5) can then rotate without driving the first element (4), thus allowing rotation of the flap without rotation of the motor, or vice versa.

For an aerodynamic flap (11) for the front of a motor vehicle, this predefined torque may be between 5 Nm and 20 Nm in one direction and in the other.

The resilient means (9) may be a spring, of compression type (FIGS. 4, 5) or of wire type (FIG. 7) for example, or a stamped spring blade or a set of springs, or a molded section (FIG. 6).

According to the embodiment of FIG. 4, the axis (8) comprises an insertion member (10) at each of its ends.

According to a preferred embodiment, the first element (4) comprises several recesses (6) on its periphery (fitting interface). When exerting the predefined transmission torque between the insertion member (10) and the first element (4), the insertion member (10) compresses the resilient means (9) and then exits the recess (6) in which it was inserted. The second element (5) can then rotate about itself without driving the first element (4). By continuing the rotation of the second element (5) and/or of the axis (8), the insertion member (10) is then capable of being inserted in a recess (6) adjacent to that from which it exited, on the periphery of the first element (4) after a predefined angle of rotation.

The aerodynamic flap (11) can thus be pushed notch by notch to close it and reopen it notch by notch (from one recess to another).

For an aerodynamic flap (13) for the front of a motor vehicle, whose rotation is close to 90°, the predefined angle of rotation between two successive notches and ideal for use, may be substantially between 10° and 30°.

Preferably, the recesses (6) are regularly distributed on the periphery of the fitting surface.

To facilitate insertion and disengagement of the insertion member (10) in a recess (6), appropriate shapes and low relative friction materials (polyamide reinforced with molybdenum disulphide, POM, greases, steel/plastic contact, etc.) are chosen. For example, advantageously, the insertion member (10) may be spherical, for example a ball, and the recess (6) may then have a complementary shape such as a half-cylinder as illustrated on FIGS. 2, 3 and 4. The half-cylinder has the advantage of facilitating the fitting of the two elements (4, 5). Alternatively, the recess (6) may be V-shaped or U-shaped.

Advantageously, in particular for vehicles with high aerodynamic forces (whether due to a large flap area or to a high maximum speed), a recess (6) comprises a slope (for a V shape in particular) or a radius of curvature (for a cylindrical shape) for disengaging the member different from the insertion slope.

An insertion slope (or radius of curvature) refers to the slope (or radius of curvature) seen by the insertion member (10) when it enters the recess (6) following a rotation in a given direction of the second element (5). Conversely, the disengagement slope (or radius of curvature) refers to the slope (or radius of curvature) seen by the insertion member (10) when it exits the recess (6) following a rotation in the same direction of the second element (5).

Thus, when the second element (5) rotates in an opposite direction, the insertion slope (or radius of curvature) becomes the disengagement slope (or radius of curvature), and vice versa.

Such an asymmetric recess (6) allows for example manual opening that is easier compared with the forced closing force, which must necessarily be greater than the aerodynamic force.

In this case, for the direction of rotation of the aerodynamic flap (11) corresponding to its opening, the recess (6) comprises a slope for disengaging the insertion member (10) that is less than the insertion slope.

According to one embodiment, the disengaging member (1) comprises a handle capable of compressing the resilient means (9) by manual action, via a yoke 11 (not shown), so as to simplify assembly and reduce the forces required to disengage the insertion member (10). This mode is especially advantageous in the case of flaps undergoing high forces when driving.

Preferably, the two elements are manufactured by injection of thermoplastic material. The first element (4) can then be made using a mold whose extraction will be in the direction of the axis (8) of revolution of this element (the recesses (6) will then be cylindrical apart from the demolding draft), the recesses (6) preferably having a semi-circular cross-section, such that the recess (6) is demolded naturally.

According to another embodiment, the second element (5) comprises several axes (8) and the first element (4) comprises at least as many recesses (6) on its periphery.

The invention also relates to an assembly (14), illustrated on FIG. 2, of a motor means (2), a shaft (3) rotated by this motor means (2), and a disengaging member (1) according to the invention. In this assembly, the first element (4) is connected to the motor means (2) by a link that enables it to be rotated by the motor means (2), and the second element (5) is attached to the shaft (3). The axis (8) is preferably substantially perpendicular to the shaft (3).

According to one embodiment, the assembly also comprises a gearbox (15), for example consisting of two gears of different size, between the motor means (2) and the shaft (3).

The disengaging member (1) can then be positioned, not only between the motor means (3) and the gearbox (15), or between the gearbox (15) and the shaft (3), but also within the gearbox (15) itself.

The invention also relates to a retractable aerodynamic system (16), illustrated on FIG. 1, for the front of a motor vehicle, comprising an assembly (13) according to the invention, and an aerodynamic flap (11) attached to the shaft (3).

The aerodynamic flap (11) is retractable, pivotally mounted between a folded position under the vehicle front bumper and a position in which the deflector projects downwards.

According to one configuration, the aerodynamic flap (11) is capable of pivoting by an angle close to 90°. In this case, the re-engagement angle after predefined disengagement is preferably substantially between 10° and 30°.

According to one embodiment, the predefined torque, to allow disengagement of the insertion member (10), is between 5 Nm and 20 Nm.

Lastly, according to a preferred embodiment of the retractable aerodynamic system, for the direction of rotation of the aerodynamic flap (11) corresponding to its opening, the recess (6) comprises a slope for disengaging the insertion member (10) that is less than the insertion slope. The insertion slope will preferably be between 50° and 80° in order to have a resilient means (9) of lower rigidity.

The invention has been described in the context of a maintenance, in other words when the vehicle is stationary and it is necessary to change the position (folded or extended) manually. However, the invention also applies to the case where the vehicle is in driving situation, and the motor forces to change the position of the flap. In this case, disengagement protects the motor from overload.

In addition, the disengaging member according to the invention applies to any type of motorized mobile system on a vehicle, whether retractable or not, whether pivoting or not.

Lastly, the invention has been described according to an example where the second element (5) carrying the resilient means (9) and the insertion member (10) is attached to the shaft (3). Obviously, the second element (5) can be attached to the motor means, while the first element (4) is attached to the shaft (3).

1. A retractable aerodynamic system for a motor vehicle, the retractable aerodynamic system comprising:
an assembly of a motor,
a shaft configured to be rotated by said motor,
a disengaging member configured to release a link between the motor and the shaft as well as an aerodynamic flap attached to the shaft,
the disengaging member including first and second elements configured to be fitted together in a direction substantially parallel to the shaft, one of the first and second elements being configured to be connected to the motor by a link, the one of the first and second elements being rotatable by the motor, and the other of the first and second elements being configured to be attached to the shaft, wherein:
the first element includes at least one recess at a fitting interface between the first and second elements;
the second element includes at least one resilient member configured to exert a radial force on the fitting interface via an insertion member configured to be inserted into the recess, keeping the first and second elements secured to one another for rotation therewith up until a predefined transmission torque between the insertion member and the first element;
the resilient member, the recess and the insertion member being configured so that, beyond said predefined transmission torque, the insertion member compresses the resilient member and exits the recess.

2. The retractable aerodynamic system according to claim 1, wherein the predefined transmission torque is between 5 Nm and 20 Nm.

3. The retractable aerodynamic system according to claim 1, wherein the resilient member is a spring.

4. The retractable aerodynamic system according to claim 1, further comprising an axis including an insertion member at each end thereof.

5. The retractable aerodynamic system according to claim 1, wherein the first element comprises a plurality of recesses on the fitting interface.

6. The retractable aerodynamic system according to claim 5, wherein the insertion member is configured to be inserted in an adjacent recess at a periphery of the first element beyond a predefined angle of rotation.

7. The retractable aerodynamic system according to claim 6, wherein the predefined angle of rotation is substantially between 10° and 30°.

8. The retractable aerodynamic system according to claim 1, wherein
the insertion member is cylindrical or spherical, and
the recess has a complementary shape.

9. The retractable aerodynamic system according to claim 1, wherein the insertion member is a ball or has a V shape.

10. The retractable aerodynamic system according to claim 1, wherein the recess comprises a slope or a radius of curvature for disengaging the member, the slope or radius of curvature of the recess being different from a slope or a radius of curvature for inserting the member.

11. The retractable aerodynamic system according to claim 1, further comprising:
a handle configured to compress the resilient member so as to reduce forces to disengage the insertion member.

12. The retractable aerodynamic system according to claim 1, wherein the first and second elements are made of thermoplastic material.

13. The retractable aerodynamic system according to claim 1, wherein
one end of the resilient member forms the insertion member, or
the insertion member is added to the resilient member by thermoplastic overmoulding.

14. The retractable aerodynamic system according to claim 1, wherein
the insertion member is a moulded section of the second element, located on the fitting interface of the second element, and
the resilient member is an area at a periphery of the insertion member having flexibility in compression such that the insertion member is configured to move radially.

15. The retractable aerodynamic system according to claim 1, wherein
the first element is connected to the motor by a link, the first element being rotatable by the motor, and
the second element is attached to the shaft.

16. The retractable aerodynamic system according to claim 1, wherein the disengaging member comprises an axis including an insertion member at each end thereof, the axis being substantially perpendicular to the shaft.

17. The retractable aerodynamic system according to claim 1, further comprising a gearbox.

18. The retractable aerodynamic system according to claim 1, wherein
the aerodynamic flap is configured to pivot by an angle of about 90°, and
the insertion member is configured to be inserted in an adjacent recess at the periphery of the first element after a predefined angle of rotation of substantially between 10° and 30°.

19. The retractable aerodynamic system according to claim 1, wherein the predefined transmission torque is between 5 Nm and 10 Nm.

20. The retractable aerodynamic system according to claim 1, wherein for the direction of rotation of the aerodynamic flap corresponding to an opening thereof, the recess comprises a slope configured to disengage the insertion member, the slope being less than the insertion slope.
